(19) United States
(12) Patent Application Publication
(10) Pub. No.: US 2006/0254024 A1
(43) Pub. Date: Nov. 16, 2006

(54) Seamless interlocking hinge assembly

(76) Inventor: Teng-Long Yong, Singapore (SG)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/125,574

(22) Filed: May 10, 2005

(51) Int. Cl. E05D 7/12

(52) U.S. Cl. 16/270

(57) ABSTRACT

The present invention provides central mailbox cluster unit having a hinge assembly that is simple to manufacture and has a hinge with seamless interlocking elements formed on a frame member of a door and on a corresponding frame member of a postal box cabinet unit that retain a linear hinge pin that extends through the coaxially aligned interlocking elements. The hinge assembly presents only a smoothly rounded housing corner with no openings or gaps for insertion of a tool when the doors of the unit are in a closed position. It is emphasized that this abstract is provided to comply with the rules requiring an abstract that will allow a searcher or other reader to quickly ascertain the subject matter of the technical disclosure. It is submitted with the understanding that it will not be used to interpret or limit the scope of the claims.

### FIELD OF INVENTION

The present invention is directed to a hinge assembly or mechanism of the type commonly used on postal box cluster units, including central mailbox units, and on commercial cabinets and cases, and the like. The present invention provides a hinge having seamless interlocking elements formed on a frame member of a door or other closure device and on a corresponding frame member of a postal box cabinet unit or other housing for retaining a linear hinge pin that extends through the central bore formed in coaxially aligned interlocking elements.

Conventional hinges of the kind commonly used in the above described applications have exhibited a number of problems and drawbacks which the present invention is intended to improve upon. These problems and drawbacks include the use of hinge components that must be individually mounted to a door and a door frame in proper relation and alignment, thereby tending to increase the complexity and cost of the manufacturing process. Additionally, such conventional hinges are typically made of sheet material that is rolled or bent to form elements capable of retaining a hinge pin. These conventional hinge elements inherently have a seam or gap along their length parallel with the hinge pin and do not completely encircle the hinge pin, thereby tending to result in a hinge that is weaker compared to one having seamless elements completely surrounding the hinge pin. Also, conventional hinges typically made of sheet material are known to wear relatively quickly thereby tending to require frequent maintenance or replacement, or if maintenance is deferred, resulting in difficult hinge operation or hinge failure that may allow access to the interior of the postal box unit.

### SUMMARY OF INVENTION

Hinge assemblies or mechanisms of the type commonly used on postal box clusters or in other commercial applications as referenced above and the like are well known. Examples of such hinge assemblies include those described in U.S. Pat. Nos. 6,328,205; 6,247,641; 6,296,181 and 5,794,844.

It is an object of the present invention to provide a hinge assembly that lends itself to relatively simple manufacture by largely automated methods such extrusion and milling.

It is also an object of the present invention to provide a hinge assembly that requires relatively little maintenance in service.

It is a further object of the present invention to provide a hinge assembly that will securely close a door, and provide no opening or gap for insertion of a tool between the door and the door frame.

It is a further object of the present invention to provide a hinge assembly that presents no protruding components and no exposed edges.

It is an additional object of the present invention to provide a strong hinge assembly having integrally formed and therefore seamless interlocking elements.

A general description of the hinge assembly of the present invention providing a strong and secure tamper resistant hinge requiring little maintenance directed to overcoming the aforementioned problems and drawbacks in a simple, novel manner are as follows. A hinge assembly extending substantially the height of a door and having seamless integrally formed interlocking elements for securing a door to a door frame is provided. The hinge assembly optionally may include spring elements positioned and adapted to urge the door open from a closed position when it is unlatched.

### BRIEF DESCRIPTION OF THE DRAWINGS

FIG. 1 is a front exploded perspective view of the hinge assembly of a preferred embodiment.

FIG. 2 is a front perspective view of the FIG. 1 embodiment installed in a representative postal box cluster unit.

FIG. 3 is a top cross-sectional view of the FIG. 1 embodiment installed in representative postal box cluster unit.

FIG. 4 is a cross-sectional view orthogonal to the hinge axis of rotation of the FIG. 1 embodiment in the closed position.

FIG. 5 is a cross-sectional view orthogonal to the hinge axis of rotation of the FIG. 1 embodiment in the open position.

FIG. 6 is a front perspective view of the FIG. 1 embodiment disassembled.

FIG. 7 is a front perspective view of the FIG. 1 embodiment assembled.

FIG. 8 is a cross-sectional view orthogonal to the hinge axis of rotation of another preferred embodiment in the closed position.

FIG. 9 is a cross-sectional view orthogonal to the hinge axis of rotation of the FIG. 8 embodiment in the open position.

FIG. 10 is a top cross-sectional detail view of the right main door hinge assembly in the closed position.

FIG. 11 is a top cross-sectional detail view of the right main door hinge assembly in a partially open position.

### DETAILED DESCRIPTION OF PREFERRED EMBODIMENTS

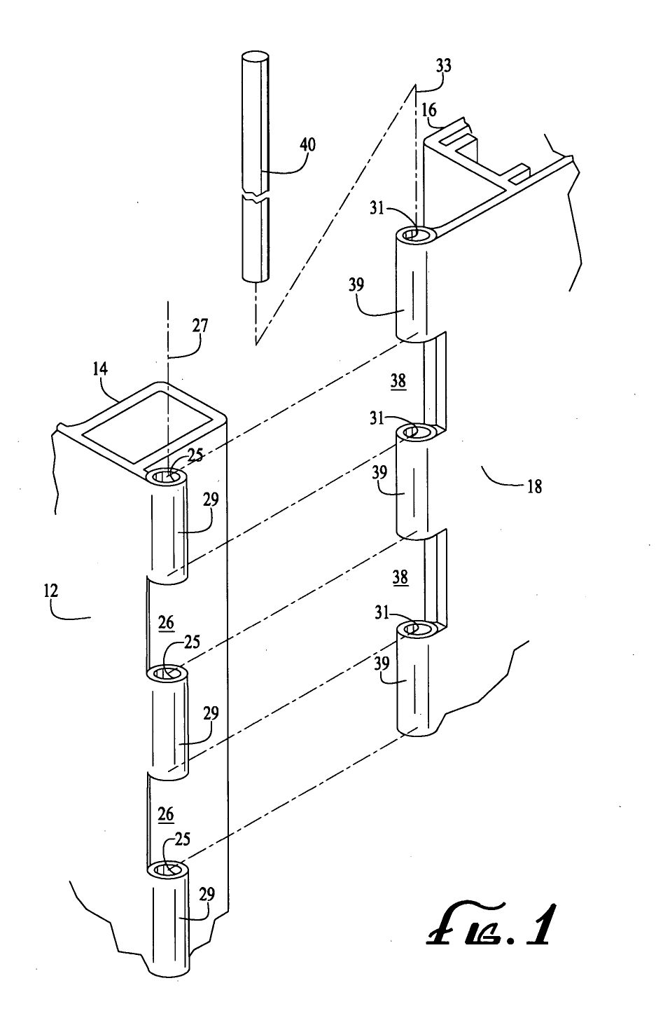

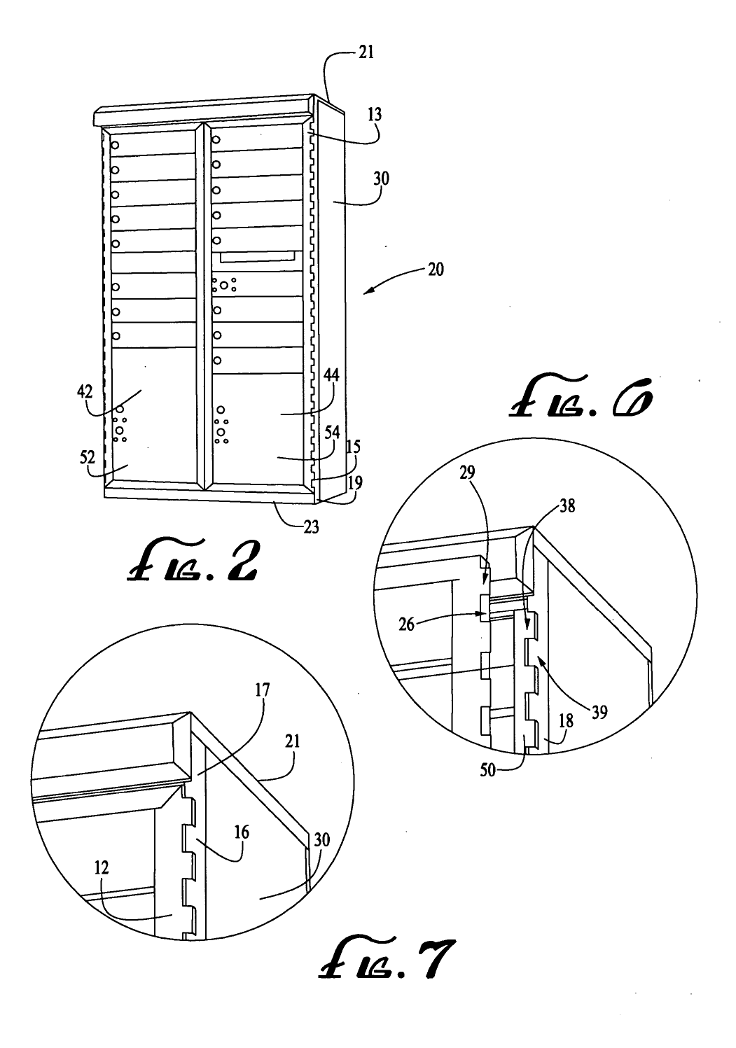

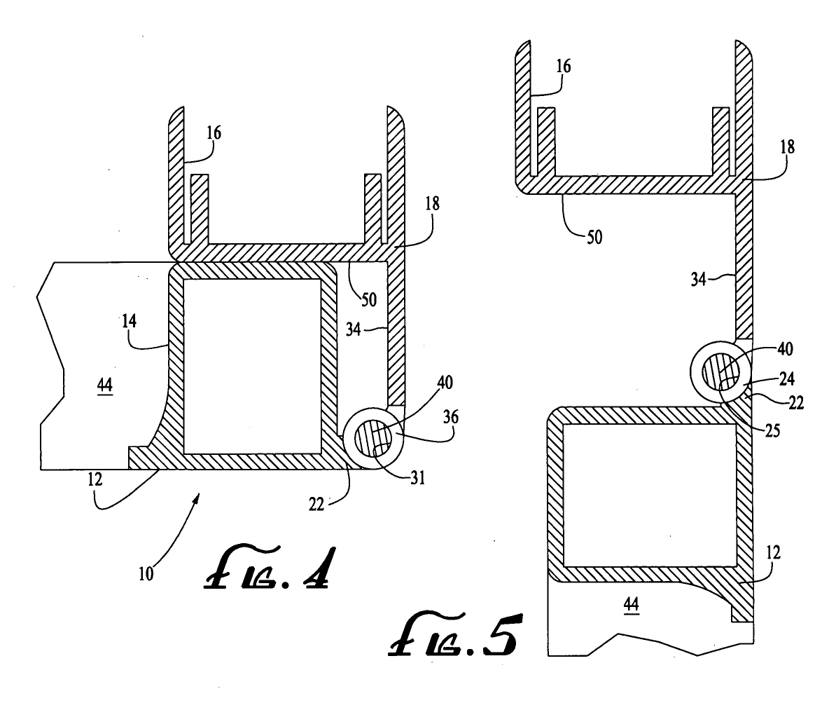

With reference to FIGS. 1-11, a cabinet or housing for a multiunit mailbox (20) including a hinge assembly (10) and including a door mounted door rail (12) portion and a housing mounted housing rail (16) portion will be described. The hinge assembly (10) is preferably formed of a relatively rigid impact resistant and corrosion resistant material such as metal or a resilient high impact polymer. For example, in one preferred embodiment the hinge structure is machined from extruded aluminum members that also form part of the door and of the doorframe of the housing, respectively. Aluminum is preferred due to its resistance to wear and tear, and it has advantageous physical properties, such as in flexion and bending, resistance to corrosion and in the capacity to readily be extruded in comparison to conventional hinges made of sheet metal. The hinge assembly (10) is mounted to a cabinet, mailbox or housing (20) having a top (21), bottom (23), left side wall (28), right side wall (30) and a front opening (32) having a height and width extending substantially the height and width of housing (20). The housing or cabinet (20) is preferably fabricated of metal or other material having strength and rigidity sufficient to function as a mailbox.

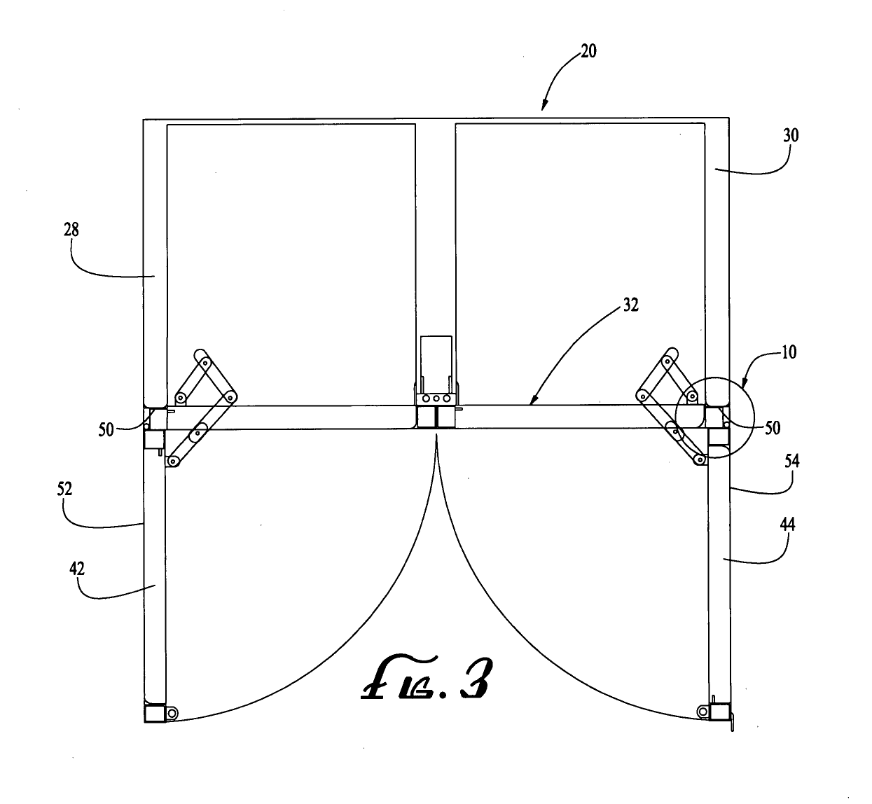

The front opening (32) is rotatably covered by a left main door (42) and a right main door (44) supported, respectively, by hinge assemblies (10) affixed to side walls (28) and (30) of housing (20). A door rail (12) of hinge assembly (10) is affixed to each of left main door (42) and right main door (44), respectively. A housing rail (16) of hinge assembly (10) is affixed to each of the left side wall (28) and the right side wall (30), respectively. The door rail (12) and housing rail (16) may each be solid or hollow, and each has a cross-section (taken orthogonal to the length of the rail) that provides sufficient strength and rigidity to function as a multiunit mailbox hinge member. It will be apparent to one or ordinary skill in the art that the rails (12), (16) may have a cross-section other than the hollow substantially rectangular cross-section as shown in FIGS. 4, 5, 8 and 9-11. The hinge assembly (10) is disposed so housing rail (16) mounted on left side wall (28) matingly interlocks with door rail (12) mounted on left main door (42). Similarly, hinge assembly (10) is disposed so housing rail (16) mounted on right side wall (30) matingly interlocks with door rail (12) mounted on right main door (44). Hinge assemblies (10) are operable to permit both main doors (42), (44) to lie in substantially the same plane to substantially cover or close front opening (32). Hinge assemblies (10) are operable to permit the main doors (42), (44) to each swing preferably through an arc of at least 90 degrees to provide access to front opening (32). Further, in one preferred embodiment, hinge assemblies (10) are spring-loaded to urge doors (42), (44) to swing open from a closed position upon release of a latching mechanism.

With further reference to FIGS. 1-11, door rail (12) of hinge assembly (10) includes a door rail body (14) that is affixed to each of a main door (42), (44) and that defines the length of door rail (12) extending along and between its upper end (13) and its lower end (15). Housing rail (16) of hinge assembly (10) includes a housing rail body (18) that is affixed to each of a left side wall (28) or a right side wall (30) of housing (20) and that defines the length of housing rail (16) extending along and between its upper end (17) and its lower end (19).

Each door rail body (14) includes a door rail body side face (22) on which is integrally formed door rail hinge tube (24) extending along the length of body (14) and having an axial bore (25) defining central longitudinal axis (27). Door rail hinge tube (24) preferably has a substantially circular exterior surface of predetermined radius measured from the central axis (27), except where tube (24) merges with side face (22) of body (14). At predetermined positions between upper end (13) and lower end (15) hinge tube (24) is interrupted or cut away to form a predetermined number of hinge pockets (26) each of predetermined length and width. The portions of hinge tube (24) remaining between the hinge pockets (26) form a predetermined number of hinge cylinders (29). The surface of each hinge pocket (26) formed in side face (22) corresponds with the projected exterior surface of hinge tube (24) and has a predetermined radius of curvature, measured from the central axis (27).

Each housing rail body (18) includes a housing rail body side wall (34) on which is integrally formed housing rail hinge tube (36) extending along the length of body (18) and having an axial bore (31) defining central longitudinal axis (33). Housing rail hinge tube (36) preferably has a substantially circular exterior surface of predetermined radius measured from the central axis (33), except where tube (36) merges with side wall (34) of body (18). At predetermined positions between upper end (17) and lower end (19) hinge tube (36) is interrupted or cut away to form a predetermined number of hinge pockets (38) each of predetermined length and width. The portions of hinge tube (36) remaining between the hinge pockets (38) form a predetermined number of hinge cylinders (39). The surface of each hinge pocket (38) formed in side wall (34) corresponds with the projected exterior surface of hinge tube (36) and has a predetermined radius of curvature, measured from the central axis (33).

The hinge pockets (26) of door rail body (14) are positioned and matingly received in interlocking relation between the hinge cylinders (39) of housing rail body (18) and the hinge pockets (38) of housing rail body (18) are positioned and matingly received in interlocking relation between the hinge cylinders (29) of door rail body (14) so that door rail body axis (27) and housing rail body axis (33) are in coaxial alignment and form a bore or channel in which axle or hinge pin (40) extending from upper ends (13), (17) to lower ends (15), (19) is received and rotatably retained. Door rail (12) and housing rail (16) are rotatably mounted on axle or hinge pin (40) and each rail (12), (16) independently rotates on hinge pin (40) through an arc preferably of at least 90 degrees in relation to each other.

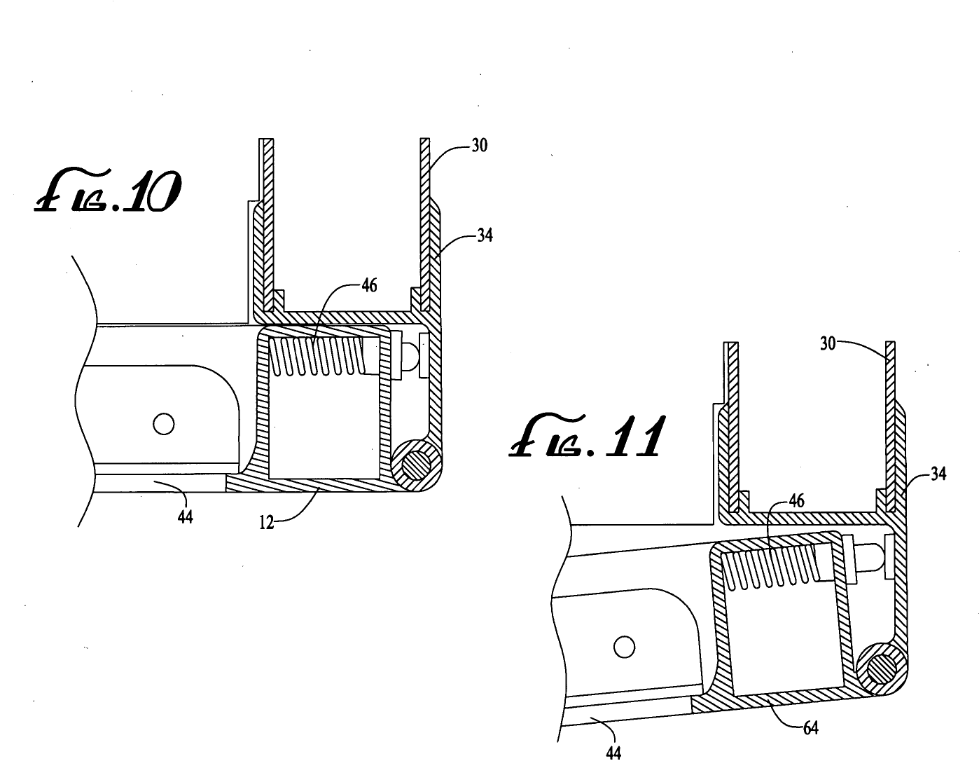

Now with reference to FIGS. 10-11, in a second embodiment of hinge assembly (10), one or more springs (46), is affixed along a portion of the door rail (12) and disposed to contact and be compressed or otherwise deformed by housing rail body side wall (34) when a main door (42), (44) is rotated to a closed position to cover a predetermined portion of front opening (32) of housing (20). Thus, each main door (42), (44) is urged by the energy stored in compressed spring (46) from a closed toward an open position when the door is unlatched.

Now with reference to FIGS. 1-11, in a third embodiment of hinge assembly (10), one or more flat or leaf type springs (51) (not shown), is affixed along a portion of housing rail body side wall (34) and disposed to contact and be compressed or otherwise deformed by door rail (12) when a main door (42), (44) is rotated to a closed position to cover a predetermined portion of front opening (32) of housing (20). Thus, each main door (42), (44) is urged by the energy stored in compressed spring (51) (not shown) from a closed toward an open position when the door is unlatched.

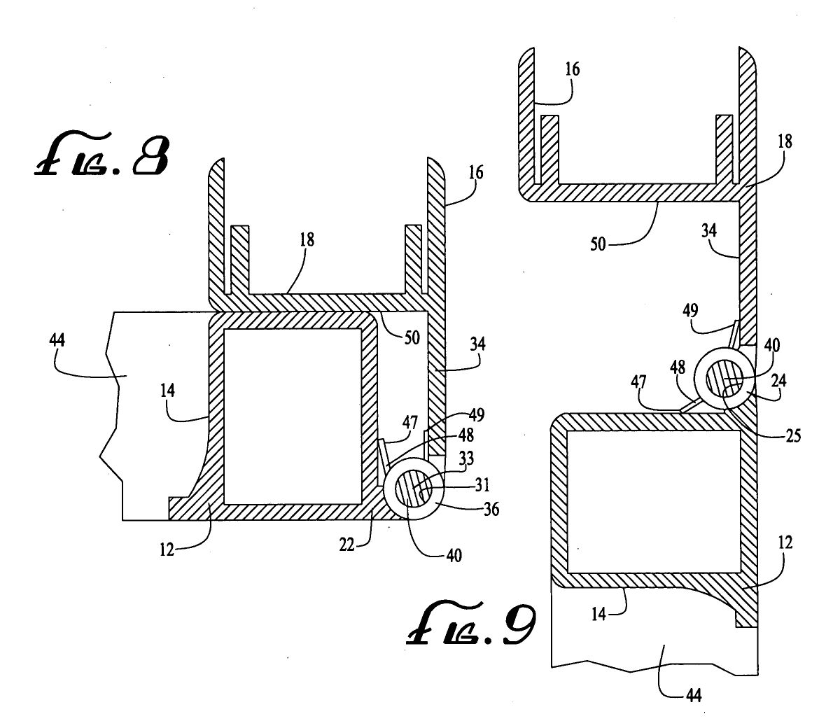

With reference now to FIGS. 8-9, in a fourth embodiment of hinge assembly (10), one or more coil springs (48) having spring arms (47), (49) are disposed on axle (40) between a hinge cylinder (29) of door rail (12) and an adjacent hinge cylinder (39) of housing rail (16). One or both of the hinge cylinders (29), (39) is adapted to accommodate in a space between adjacent hinge cylinders one or more coil springs (48). One coil spring arm (47) is disposed in contact with housing rail body side wall (34). The other coil spring arm (49) is disposed to come into contact with door rail (12) to cause coil spring (48) to be deformed by door rail (12) when a main door (42), (44) is rotated toward a closed position to cover a predetermined portion of front opening (32) of housing (20). Thus, each main door (42), (44) is urged by the energy stored in one or more of deformed coil springs (48) from a closed toward an open position when the door is unlatched.

As will now be apparent to one having ordinary skill in the art, each embodiment of the present invention discussed above presents only a smoothly rounded housing corner with no openings or gaps for insertion of a tool when each main door (42), (44) is in a closed position covering a predetermined portion of front opening (32) of housing (20). It will also be apparent to one or ordinary skill in the art that the hinge assembly may be mounted in the configuration as shown in FIGS. 1-11 where each main door (42), (44) covers the end surface (50) of a side wall (28), (30) of housing (20) when each main door (42), (44) is in a closed position, or alternatively, the hinge assembly may be mounted in an alternative configuration so that when each main door (42), (44) is in a closed position the end surface (50) of a side wall (28), (30) is not covered by a main door (42), (44), but rather is substantially flush with the outward (relative to housing opening (32)) surface (52), (54), respectively, of a main door (42), (44). In other words, in the alternative mounting configuration described, the main doors (42), (44) are set into opening (32) and are surrounded by the structures defining the top (21), bottom (23) and two sides (28), (30) of housing (20).

While the present invention has been described in connection with what are presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

What is claimed is:

1. A multiunit mailbox comprising:
a housing defining a height and width having a first side wall a second side wall and a front opening;
a housing rail having a length affixed to at least one of the first side wall and second side wall;
the housing rail having an integrally formed housing rail hinge tube extending along the length of the housing rail;
the housing rail hinge tube having a housing rail axial bore adapted to receive a hinge pin defining a housing rail longitudinal axis;
a plurality of alternating housing rail hinge pockets of predetermined length and housing rail hinge cylinders of predetermined length formed in housing rail hinge tube at predetermined positions along the housing rail;
a door extending substantially along the height of the front opening and extending a sufficient distance to overlay a portion of the front opening in the width direction;
a door rail affixed to the door and having a length;
the door rail having an integrally formed door rail hinge tube extending along the length of the door rail;
each door rail hinge tube having a door rail axial bore adapted to receive a hinge pin defining a door rail longitudinal axis;
a plurality of alternating door rail hinge pockets of predetermined length and door rail hinge cylinders of predetermined length formed in door rail hinge tube at predetermined positions along the door rail;
each of the plurality of the door rail hinge pockets is adapted to receive one of the plurality of housing rail hinge cylinders;
each of the plurality of the housing rail hinge pockets is adapted to receive one of the plurality of door rail hinge cylinders;
the plurality of door rail hinge pockets and door rail hinge cylinders formed on the door rail and the plurality of housing rail hinge cylinders and housing rail hinge pockets formed on the housing rail are matingly engaged with the door rail axial bore of each door rail hinge cylinder and the housing rail axial bore of each housing rail hinge cylinder in coaxial alignment;
a hinge pin rotatably disposed and retained in the coaxially aligned door rail axial bore of the plurality of door rail hinge cylinders and housing rail axial bore of the plurality of housing rail hinge cylinders;
the door rail is rotatable about the hinge pin through an arc of at least 90 degrees in relation to the housing rail.

2. A multiunit mailbox comprising:
a housing having a height and width including a front opening a first side wall and a second side wall;
a housing rail having a length affixed to at least one of the first side wall and second side wall;
the housing rail having at least one seamless integrally formed housing rail hinge cylinder disposed at a predetermined position along the housing rail;
a housing rail longitudinal axis extending through a housing rail hinge cylinder axial bore formed in the at least one seamless integrally formed housing rail hinge cylinder;
at least one housing rail hinge pocket formed adjacent the at least one seamless integrally formed housing rail hinge cylinder;
a door extending substantially along the height of the front opening and extending a sufficient distance to overlay a portion of the front opening in the width direction;
a door rail affixed to the door and having a length;
the door rail having at least one door rail hinge cylinder disposed at a predetermined position along the door rail;
a door rail longitudinal axis extending through a door rail hinge cylinder axial bore formed in the at least one door rail hinge cylinder;
at least one door rail hinge pocket formed adjacent the at least one door rail hinge cylinder;
the door rail longitudinal axis and the housing rail longitudinal axis are disposed in coaxial alignment;
a hinge pin adapted to be received in the door rail hinge cylinder axial bore and in the housing rail hinge cylinder axial bore;
the hinge pin rotatably disposed and retained in the coaxially aligned door rail axial bore and housing rail axial bore;
the door rail is rotatable about the hinge pin through an arc of at least 90 degrees in relation to the housing rail.

3. The multiunit mailbox of claim 1 further including:
at least one spring adapted to store energy when deformed affixed to the door rail;
the housing rail disposed to cause the at least one spring to deform when rotated from a first position to a second position relative to the door rail.

4. The multiunit mailbox of claim 1 further including:
at least one spring affixed to the housing rail and adapted to store energy when deformed;
the door rail disposed to cause the at least one spring to deform when rotated from a first position to a second position relative to the housing rail.

5. The multiunit mailbox of claim 1 further including:
at least one coil spring having a first spring arm and a second spring arm disposed around hinge pin between one of the plurality of housing rail hinge cylinders and one of the plurality of door rail hinge cylinders and adapted to store energy when deformed;
the first spring arm disposed in contact with the housing rail;
the second spring arm disposed to contact the door rail and to deform the at least one coil spring when the door rail is rotated from a first position to a second position relative to the housing rail.
